(19) United States
(12) Patent Application Publication
(10) Pub. No.: US 2024/0180249 A1
(43) Pub. Date: Jun. 6, 2024

(54) Close-Packed Heating Mechanism and Atomization Device Comprising The Same

(71) Applicant: SHENZHEN HUACHENGDA PRECISION INDUSTRY CO. LTD., Shenzhen (CN)

(72) Inventor: Ping CHEN, Shenzhen (CN)

(73) Assignee: SHENZHEN HUACHENGDA PRECISION INDUSTRY CO. LTD., Shenzhen, GD (CN)

(21) Appl. No.: 18/552,914

(22) PCT Filed: Jun. 3, 2021
(86) PCT No.: PCT/CN2021/098197

§ 371 Date: Sep. 28, 2023

(51) Int. Cl. A24F 40/46; A24F 40/10; H05B 3/00

(52) U.S. Cl. CPC A24F 40/46; A24F 40/10; H05B 3/0019; H05B 2203/021

(57) ABSTRACT

Disclosed are a close-packed heating mechanism and an atomization device comprising the same. The close-packed heating mechanism includes heating circuits configured for evaporating liquid, and electrodes connected to a power supply unit. At least two heating circuits are disposed between the two electrodes in parallel to form a circuit group. The distance between adjacent heating circuits in the circuit group or the distance between at least parts of adjacent circuit groups is less than 0.5 mm to form a close-packed structure; or, the distance between at least parts of the adjacent heating circuits in the circuit group and the distance between at least parts of the adjacent circuit groups are less than 0.5 mm to form a close-packed structure; and the distance between other parts is greater than the distance in the close-packed structure. The atomization device includes a liquid transfer unit and the heating mechanism.

### FIELD

The invention belongs to the technical field of atomization, and relates to a close-packed heating mechanism and an atomization device comprising the same.

### BACKGROUND

Electrothermal atomization, a new atomization technique emerging in recent years, can heat and atomize liquid into steam by means of heat energy generated by means of the heat effect of resistors, and has been widely applied to medical equipment, intelligent household appliances and consumer electronic products at present. E-cigarettes, as novel tobacco products for replacing traditional cigarettes, are very popular with domestic and overseas users, and can heat e-liquid by means of heat energy into aerosol particles to be inhaled by users. E-liquid is mainly prepared from propylene glycol, vegetable glycerin, nicotine, essences, sweeteners, acidulants, and other additives, and with the propylene glycol as a carrier of solvents such as the nicotine and the essences, and the vegetable glycerin as a carrier of smoke, a large amount of atomized steam can be generated when the e-liquid is heated. During the atomization process, e-liquid is heated to be evaporated mainly by means of heat generated by a heating unit. Since the e-liquid comprises multiple components with different boiling points (for example, the boiling point of the propylene glycol is 184° C., the boiling point of the glycerin is 290° C., the boiling point of the nicotine is 247° C., and the boiling point of the essences, the sweeteners and the acidulants is typically within 100-250° C.), when the heating unit is electrified, the temperature distribution range of the atomization surface should be wide enough to ensure that all the substances can be volatilized to satisfy requirements of users for different tastes and flavors. However, heat generated by heating units in the prior art is difficult to adjust, so it is hard to obtain suitable temperatures for atomizing different substances to satisfy the requirements of users for different flavors.

Flat heating units, when designed to be thin, typically have a large width to reach the corresponding resistance, and the flatter the heating units, the larger the contact area between the heating units and liquid transfer materials, and the higher the heat utilization rate. So, flat heating units are used more and more widely in the field of electronic atomization. However, flat heating units in the prior art have the following defects:

Heating circuits are designed to be thin and wide, and the middle of the heating circuits contacts with a liquid transfer unit, so atomized steam will be blocked by the heating circuits and cannot be diffused out easily, and carbon deposition may be caused due to heat accumulation; and due to the poor heat dissipation performance of heating elements, severe heat waste is caused, leading to low heat efficiency.

### SUMMARY

The technical issue to be settled by the invention is to overcome the defects in prior art by providing a close-packed heating mechanism and an atomization device, which can realize gradient temperature distribution and uniform heat in all areas respect to the entire heating mechanism, can fully atomize components with different boiling points, and can solve the problem that atomized steam in the middle of heating circuits is blocked and cannot be diffused out normally due to an excessively large width.

The technical solution adopted by the invention to settle the above technical issue is as follows:
A close-packed heating mechanism, comprising heating circuits configured for evaporating liquid, and electrodes configured for being connected to a power supply unit. At least two said heating circuits are disposed between two electrodes in parallel to form a circuit group, and all the heating circuits in the circuit group extend from one of the electrodes to the other of the electrodes;
In an arrangement pattern formed by all the heating circuits, a distance between adjacent heating circuits in the circuit group or a distance between at least parts of adjacent circuit groups is less than 0.5 mm to form a close-packed structure, or, a distance between at least parts of the adjacent heating circuits in the circuit group and a distance between at least parts of the adjacent circuit groups are less than 0.5 mm to form a close-packed structure; and a distance between other parts of the adjacent heating circuits and the adjacent circuit groups is greater than the distance in the close-packed structure.

Preferably, the distance between the adjacent heating circuits in the close-packed structure is 0.01-0.5 mm.

Preferably, each of the heating circuits is a linear unit, a curved unit, or a structure formed by end-to-end connection or intersection of at least one of the linear unit or the curved unit.

Preferably, each of the heating circuits has a diameter or width, which is constant or substantially constant, or gradually increases or decreases or is regular with respect to a center of the heating mechanism.

Preferably, multiple heating circuits are the same or substantially the same in diameter or width.

Preferably, all the heating circuits have a diameter or width, which gradually increases or decreases or is regular with respect to a center of the heating mechanism.

Preferably, in the circuit group, the distance between the adjacent heating circuits keeps constant from one end to other end, or gradually decreases from a middle to two ends of the heating circuits, or gradually increases from the middle to the two ends of the heating circuits.

Preferably, all the heating circuits are of an integrally-formed integrated structure.

Preferably, two adjacent said heating circuits are connected through reinforcing members.

Preferably, all the reinforcing members are uniformly distributed on the heating circuits; or, all the reinforcing members are arranged symmetrically with respect to a middle of the heating circuits; or, all the reinforcing members are disposed at bends or turns.

Preferably, the reinforcing members are rod-shaped, strip-shaped or plate-shaped, and are in a linear shape, a curved shape, or in a shape of the combination of at least one linear shape and/or curved shape.

An atomization device, comprising a liquid transfer unit, and the heating mechanism described above. The heating mechanism is inlaid in or attached to a surface of the liquid transfer unit.

The invention has the following specific beneficial effects:
1. Under the condition of the same resistance, the heating circuits made from the same material are thinner, and the contact area between the heating circuits and a liquid transfer unit is greater. That is, the heating circuits have a greater contact area.
2. At least two heating circuits are arranged in parallel, the distance between the parallel heating circuits and/or circuit groups is small, less than 0.5 mm, to form the close-packed structure, and the distance between the other parts is large, such that heat will be overlapped in the area of the close-packed structure due to heat conduction and radiation of the heating circuits, the temperature in the area of the close-packed structure will be much higher than that in the area of the non-close-packed structure. Thus, a regional temperature gradient is formed to ensure that components with different evaporating temperatures can be volatilized, and this is particularly beneficial to the volatilization of some essence molecules in e-liquid, and different tastes can be obtained to satisfy the requirements of different users.
3. When different tastes are designed and tried, heat in the atomization area can be adjusted by adjusting the distance between adjacent heating circuits to rapidly obtain a desired taste.
4. The problem that thin heating elements with an excessively large width block atomized steam can be effectively solved.

### BRIEF DESCRIPTION OF THE DRAWINGS

The invention will be further described below in conjunction with accompanying drawings and embodiments. In the drawings:

FIG. 1 is a structural view of Embodiment 1-1 of the invention;

FIG. 2 is a structural view of Embodiment 1-2 of the invention;

FIG. 3 is a structural view of Embodiment 1-3 of the invention;

FIG. 4 is a structural view of Embodiment 1-4 of the invention;

FIG. 5 is a structural view of Embodiment 1-5 of the invention;

FIG. 6 is a structural view of Embodiment 1-6 of the invention;

FIG. 7 is a structural view of Embodiment 1-7 of the invention;

FIG. 8 is a structural view of Embodiment 1-8 of the invention;

FIG. 9 is a structural view of Embodiment 1-9 of the invention;

FIG. 10 is a structural view of Embodiment 1-10 of the invention;

FIG. 11 is a structural view of Embodiment 1-11 of the invention;

FIG. 12 is a structural view of Embodiment 1-12 of the invention;

FIG. 13 is a top view of Embodiment 2 of the invention;

FIG. 14 is a sectional view of Embodiment 2 of the invention.

### DESCRIPTION OF THE EMBODIMENTS

To gain a better understanding of the technical features, purposes and effects of the invention, specific embodiments of the invention will be described in detail below in conjunction with the accompanying drawings.

When one component is defined as being “fixed on” or “disposed on” the other component, it may be directly or indirectly located on the other component. When one component is defined as being “connected to” the other component, it may be directly or indirectly connected to the other component.

Terms such as “upper”, “lower”, “left”, “right”, “front”, “back”, “vertical”, “horizontal”, “top”, “bottom”, “inner” and “outer” are used to indicate directions or positions based on the accompanying drawings merely for facilitating the following description, and should not be construed as limitations of the technical solutions of the invention. Terms such as “first” and “second” are merely used for a purpose of description, and should not be construed as indicating or implying relative importance or implicitly indicating the number of technical features referred to. Unless otherwise expressly defined, “multiple” refer to two or more.

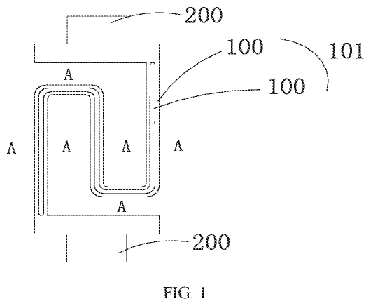

Embodiment 1: As shown in FIG. 1-FIG. 12, a close-packed heating mechanism comprises heating circuits 100 configured for evaporating liquid, and electrodes 200, wherein at least two heating circuits 100 are disposed between the two electrodes 200 in parallel to form a circuit group 101, and all the heating circuits 100 in the circuit group 101 extend from one electrode 200 to the other electrodes 200. In an arrangement pattern formed by all the heating circuits 100, the distance between adjacent heating circuits 100 in each circuit group 101 or the distance between at least parts of adjacent circuit groups 101 is less than 0.5 mm to form a close-packed structure, or the distance between parts of the adjacent heating circuits 100 in each circuit group 101 and the distance between parts of the adjacent circuit groups 101 are less than 0.5 mm to form a close-packed structure, and the distance between the other parts of the adjacent heating circuits 100 or adjacent circuit groups 101 is greater than the distance between the adjacent heating circuits 100 or adjacent circuit groups 101 in the close-pack structure. The circuit group 101 is a structure formed by multiple heating circuits 100, and a heating part of the heating mechanism is a uniform planar structure, a uniform curved structure, or other structures formed by bending and turning the circuit group 101.

Compared with the prior art, one or more existing heating circuits 100 are changed into a locally uniform close-packed structure formed by at least two heating circuits 100. In the close-packed structure, the distance between adjacent heating circuits 100 is less than 0.5 mm and is preferably 0.01-0.5 mm, which is much smaller than the distance between heating circuits 100 in the prior art. “Adjacent heating circuits 100” refer to heating circuits 100 adjacent to each other in the arrangement pattern, that is, “adjacent heating circuits 100” not only refer to adjacent heating circuits 100 in the same circuit group, but also refer to two adjacent heating circuits 100 in two adjacent circuit groups in the arrangement pattern. On the one hand, the close-packed structure makes the distance between adjacent heating circuits 100 small, and heat will be overlapped due to heat conduction and radiation of the heating circuits 100, so the temperature in the area of the close-packed structure will be much higher than that in the area of a non-close-packed structure, and a regional temperature gradient is formed to ensure that components with different evaporating temperatures can be volatilized. On the other hand, the temperature can be regulated by adjusting the distance between adjacent heating circuits 100 to ensure that essences with different flavors can be effectively volatilized at different temperatures, and the specific distance between adjacent heating circuits 100 can be set as actually needed.

In the invention, the main structure configured for heating is the heating circuits 100 which are linear on the whole, two ends of the heating circuits 100 are connected to the electrodes 200, multiple heating circuits 100 are arranged in a flat plane or curved plane to generate heat within a certain range to realize full atomization of e-liquid. To guarantee uniform atomization, the heating circuits 100 of the entire heating mechanism are arranged regularly. Because parts of the heating circuits form close-packed structures, the heating circuits 100 in the invention are grouped or bundled to form different pattern structures, and the number of the heating circuits 100 is generally 2-30 as actually needed, preferably 2-15. The heating circuits 100 are made of metal. All the heating circuits are of an integrally-formed integrated structure, such that the uniformity of the close-packed structure is guaranteed, and the probability of fractures and cracks of thin heating circuits is lowered.

All the heating circuits 100 are connected between the two electrodes 200, that is, all the heating circuits 100 are connected in parallel between the two electrodes 200. The circuit groups 101 may be arranged in various forms, and in order to form a flat plane or curved plane, the circuit groups 101 may be arranged in a tortuous form, a staggered form, a linear form or a curved form. When the number of the heating circuits 100 is small, the heating circuits 100 may be arranged in a tortuous or staggered form; and when the number of the heating circuits 100 is large, the heating circuits 100 may be arranged in a linear form or curved form. There are many different implementations of the distance between adjacent heating circuits 100 in the circuit group 101: the distance between adjacent heating circuits 100 keeps constant from one end to the other end of the heating circuits 100; or, the distance between adjacent heating circuits 100 at different positions varies, for example, the distance between the adjacent heating circuits 100 decreases gradually from the middle to two ends of the heating circuits 100, or the distance between adjacent heating circuits 100 increases gradually from the middle to two ends of the heating circuits 100. Whether the distance between adjacent heating circuits 100 varies depends on actual needs, and preferably, the distance between adjacent heating circuits 100 keeps constant from one end to the other end of the heating circuits 100.

The actual purpose of the invention is to form a structure capable of realizing overall uniform heating and forming local temperature gradients. “Overall uniform heating” means that high-temperature areas and low-temperature areas are uniformly distributed in a formed heating plane rather than being concentrated at one or several positions. “Forming local temperature gradients” means that temperature gradients are formed around the close-packed structure.

Each of the heating circuits 100 is a linear unit, a curved unit, or a structure formed by end-to-end connection or intersection of at least one linear unit or curved unit. The invention has no limitation in the specific structure of the heating circuits 100 as long as the circuit group 101 formed by the heating circuits 100 is a relatively uniform structure, which means that the total width or coverage of the heating circuits 100 at different positions is basically constant. Preferably, the diameter or width of each heating circuit 100 is constant or basically constant; or, in order to maintain the temperature gradient between different areas, the diameter or width of each heating circuit 100 gradually increases or decreases or is regular with respect to the center of the heating mechanism.

In the same circuit group 101, the diameter or width of each of the heating circuits 100 is constant or basically constant; or, the diameter or width of each of the heating circuits 100 gradually increases or decreases or is regular with respect to the center of the heating mechanism. The center of the heating mechanism may be a central point of the heating mechanism, or a longitudinal central axis or traverse central axis of the heating mechanism. The specific width or diameter of the heating circuits 100 is designed as actually needed.

Specifically, the heating circuit 100 has many different structures:

First implementation: the heating circuit 100 is formed by one linear unit or multiple linear units. The one linear unit linearly extends from one electrode 200 to the other electrode 200. The multiple linear units are connected end-to-end to form a linear or tortuous heating circuit 100.

Second implementation of the heating circuit 100: the heating circuit 100 is formed by one curved unit or multiple curved units. The one curved unit may extend from one electrode 200 to the other electrode 200. The multiple curved units are connected end-to-end to form the heating circuit 100.

Third implementation of the heating circuit 100: the heating circuit 100 is formed by one or more linear units and curved units which are connected end-to-end, and the liner units and the curved units are arranged separately or alternately.

Fourth implementation of the heating circuit 100: the heating circuit 100 is formed by crossed or staggered connection of multiple linear units, wherein “crossed or staggered connection” means that multiple heating circuits 100 extend in different directions and intersect or are staggered in one extension direction. Wherein, “crossed connection” means that multiple linear units are connected directly, and “staggered connection” means that multiple linear units are connected through connecting pieces 200 or head-dissipation members 300.

Fifth implementation of the heating circuit 100: the heating circuit 100 is formed by crossed or staggered connection of multiple curved units. Wherein, “crossed connection” means that multiple curved units are connected directly, and “staggered connection” means that multiple curved units are connected through reinforcing members 300.

Sixth implementation of the heating circuit 100: the heating circuit 100 is formed by crossed or staggered connection of at least one linear unit and at least one curved unit. This technical solution is formed by combining the fourth implementation and the fifth implementation.

In order to improve the flatness and supporting performance of the entire heating mechanism, reinforcing members 300 are disposed between adjacent heating circuits 100. The reinforcing members 300 are rod-shaped, strip-shaped or plate-shaped, and are in a linear shape, a curved shape, or in a shape of the combination of at least one linear shape and/or curved shape. From the aspect of the width of the reinforcing members 300, the reinforcing members 300 may be narrow rod-shaped structures, strip-shaped structures with a certain width, or plate-shaped structures with a relatively large width. On the whole or from the aspect of the length of the reinforcing members 300, the reinforcing members 300 may be in a linear shape, a curved shape, or in a shape of the combination of at least one linear shape and/or curved shape. Here, “the combination of at least one linear shape and/or curved shape” means that the reinforcing member 300 may be formed by end-to-end connection or crossed connection of multiple linear parts, the reinforcing member 300 may be formed by end-to-end connection or crossed connection of multiple linear parts, or the reinforcing member 300 may be formed by end-to-end connection or crossed connection of multiple linear parts or curved parts, or the reinforcing member 300 may be formed by curved parts and linear parts on different sides. The reinforcing members 300 may arranged in parallel or not in parallel, which depends on actual needs. In addition, by connecting multiple heating circuits 100 through the reinforcing members 300, a plane formed by the heating circuits 100 is smooth and is unlikely to curl upwards.

The reinforcing members 300 may be connected to any position of the heating circuits 100. In order to maintain flatness and uniform heat conduction, all reinforcing members 300 are preferably distributed on the heating circuits 100 uniformly, or arranged symmetrically with respect to the middle of the heating circuits 100, or arranged in a crossed manner, and are preferably arranged at bends or turns. The reinforcing members 300 may be connected transversely, axially or obliquely with respect to the heating circuits 100. Adjacent reinforcing members 300 may be arranged in a spaced manner or in parallel.

To further describe the invention, several specific embodiments are described in detail below by way of examples:

Embodiment 1-1: As shown in FIG. 1, a close-packed heating mechanism comprises heating circuits 100 for evaporating liquid, and electrodes 200, wherein two parallel heating circuits 100 are arranged between the two electrodes 200 to form a circuit group 101 of a close-packed structure. The two heating circuits 100 are parallel to each other, the distance between the two heating circuits 100 keeps constant from one end the other end, the two heating circuits 100 are identical in width, and the width of each heating circuit 100 keeps constant. All the heating circuits 100 in the circuit group 101 extend from one electrode 200 to the other electrode 200 in a same direction, and each heating circuit 100 is a structure formed by multiple linear units which are connected end-to-end. An arrangement pattern formed by all the heating circuits 100 is a rectangular wave structure formed by multiple continuous rectangles, the heating circuits 100 form a planar structure in a plane, and turns of the heating circuits 100 are arc-shaped, such that acute angles will not be formed at the turns, and the heating circuits 100 are not prone to being fractured. The distance between the adjacent heating circuits 100 in the circuit group 101 is 0.3 mm, and the distance between adjacent circuit groups 101 is 3 mm. Areas outside the circuit groups 101, namely the widths of the adjacent circuit groups 101, keep the same or basically the same after the circuit groups 101 are turned repeatedly, such that a uniform heating structure is formed, and stable evaporation and atomization can be realized in different areas; and areas covered by the heating circuits 100 in the circuit groups 101 are high-temperature areas, and areas A outside the circuit groups 101 are relatively low-temperature areas, and components with different boiling points can be atomized by means of the high-temperature areas and the low-temperature areas.

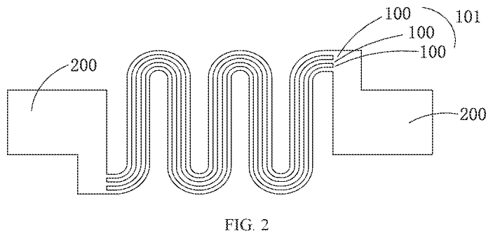

Embodiment 1-2: As shown in FIG. 2, a close-packed heating mechanism in this embodiment is improved based on Embodiment 1-1 specifically in the following aspects: the number of the heating circuits 100 is increased to three, each of the heating circuits 100 in the circuit group 101 is a structure formed by linear units and curved units (arc-shaped units) which are connected alternately rather than the rectangular structure, the distance between adjacent heating circuits 100 in the circuit group 101 is 0.01 mm, and the distance between adjacent circuit groups 101 is greater than the distance between adjacent heating circuits 100 and is 2 mm. The close-packed heating mechanism in this embodiment is identical with the close-packed heating mechanism in Embodiment 1-1 in other structures, and will not be detailed anymore here.

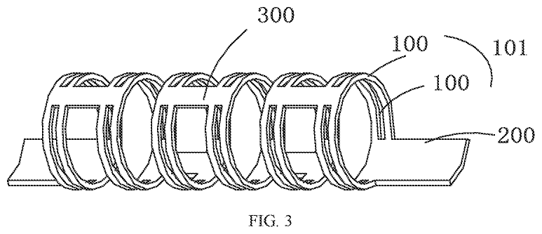

Embodiment 1-3: As shown in FIG. 3, a close-packed heating mechanism in this embodiment is improved based on Embodiment 1-1 specifically in the following aspects: each of the heating circuits 100 in the circuit group 101 is a loop or helical structure formed by curved units, the distance between adjacent heating circuits 100 in the circuit group 101 is 0.5 mm, and the distance between adjacent circuit groups 101 is 5 mm; and reinforcing members 300 are disposed between adjacent heating circuits 100, and the reinforcing member 300 are connected with only two adjacent heating circuits 100, or are connected with multiple heating circuits 100. The close-packed heating mechanism in this embodiment is identical with the close-packed heating mechanism in Embodiment 1-1 in other structures, and will not be detailed anymore here.

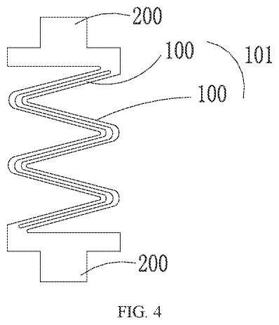

Embodiment 1-4: As shown in FIG. 4, a close-packed heating mechanism in this embodiment is improved based on Embodiment 1-1 specifically in the following aspects: each of the heating circuits 100 in the circuit group 101 is a zigzag structure formed by linear units, the distance between adjacent heating circuits 100 in the circuit group 101 is 0.1 mm, and the maximum distance between adjacent circuit groups 101 is 5 mm; and the turns of the heating circuits 100 are wider than other portions of the heating circuits 100, such that the overall structural strength is enhanced. The close-packed heating mechanism in this embodiment is identical with the close-packed heating mechanism in Embodiment 1-1 in other structures, and will not be detailed anymore here.

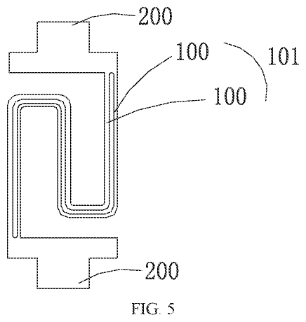

Embodiment 1-5: As shown in FIG. 5, a close-packed heating mechanism in this embodiment is improved based on Embodiment 1-1 specifically in the following aspect: the width of one of the two heating circuits 100 is greater than that of the other heating circuit 100. The close-packed heating mechanism in this embodiment is identical with the close-packed heating mechanism in Embodiment 1-1 in other structures, and will not be detailed anymore here.

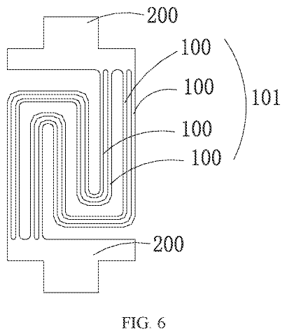

Embodiment 1-6: As shown in FIG. 6, a close-packed heating mechanism in this embodiment is improved based on Embodiment 1-1 specifically in the following aspects: the number of the heating circuits 100 is increased to four, each of the heating circuits 100 in the circuit group 101 is a structure formed by linear units and curved units (arc-shaped units) alternately rather than the rectangular structure, and the distances between adjacent heating circuits 100 in the circuit group 11 are different, wherein the distance between two outer adjacent heating circuits 100 is 0.05 mm, the distance between two middle heating circuits 100 is 2 mm, and the distance between two adjacent circuit groups 101 is greater than the distances between the adjacent heating circuits 100 and is 2 mm. The close-packed heating mechanism in this embodiment is identical with the close-packed heating mechanism in Embodiment 1-1 in other structures, and will not be detailed anymore here.

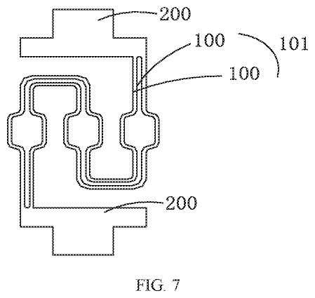

Embodiment 1-7: As shown in FIG. 7, a close-packed heating mechanism in this embodiment is improved based on Embodiment 1-1. In embodiment 1-6, the distance between two adjacent heating circuits 100 in the same circuit group is constant or basically constant at different positions. In this embodiment, the distance between two adjacent heating circuits 100 in the circuit group 101 varies at different positions, wherein the distance between two adjacent heating circuits 100 in the middle of the heating mechanism is greater than the distance between the two adjacent heating circuits 100 at other positions of the heating mechanism, the distance between two middle heating circuits 100 is 2 mm, and the distance between two adjacent circuit groups 101 is greater than the distance between two adjacent heating circuits 100 and is 2 mm. The close-packed heating mechanism in this embodiment is identical with the close-packed heating mechanism in Embodiment 1-1 in other structures, and will not be detailed anymore here.

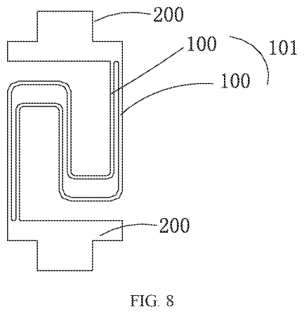

Embodiment 1-8: As shown in FIG. 8, a close-packed heating mechanism in this embodiment is improved based on Embodiment 1-1. Identical with Embodiment 1-7, the distance between two adjacent heating circuits 100 in the circuit group 101 varies at different positions in this embodiment, wherein as shown, the distance between two adjacent heating circuits 100 in the horizontal direction of the heating mechanism is greater than the distance between the two adjacent heating circuits 100 at other positions of the heating mechanism, the distance between the two adjacent heating circuits 100 in the horizontal direction is 2 mm, the distance between the two heating circuits 100 in the vertical direction is 0.3 mm, and distance between two adjacent circuit groups 101 is greater than the distance between two adjacent heating circuits 100 and is 5 mm. The close-packed heating mechanism in this embodiment is identical with the close-packed heating mechanism in Embodiment 1-1 in other structures, and will not be detailed anymore here.

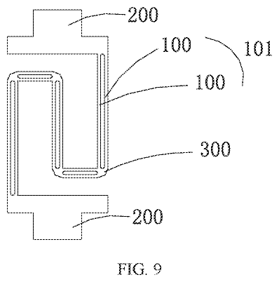

Embodiment 1-9: As shown in FIG. 9, a close-packed heating mechanism in this embodiment is improved based on Embodiment 1-1. In this embodiment, reinforcing members 300 are disposed between the two adjacent heating circuits 100, and are configured for enhancing the strength of the entire heating mechanism to protect the closely arranged heating circuits 100 against fractures. The reinforcing members 300 are disposed at all turns, which are most likely to fracture, of the rectangular wave structure, such that the overall strength is improved. The close-packed heating mechanism in this embodiment is identical with the close-packed heating mechanism in Embodiment 1-1 in other structure, and will not be detailed anymore here.

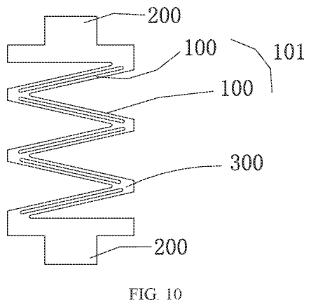

Embodiment 1-10: As shown in FIG. 10, a close-packed heating mechanism in this embodiment is improved based on Embodiment 1-4. Reinforcing members 300 are disposed between the two adjacent heating circuits 100, and are disposed at all turn, such that the strength of the entire heating mechanism is enhanced. The close-packed heating mechanism in this embodiment is identical with the close-packed heating mechanism in Embodiment 1-4 in other structures, and will not be detailed anymore here.

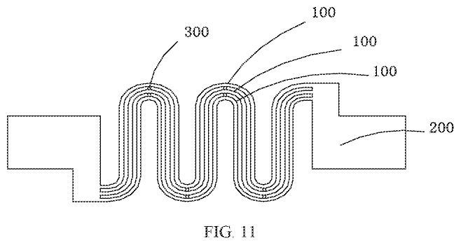

Embodiment 1-11: As shown in FIG. 11, a close-packed heating mechanism in this embodiment is improved based on Embodiment 1-2. Reinforcing members 300 are disposed between the two adjacent heating circuits 100, and are disposed on parts of the arc-shaped units, such that the strength of the entire heating mechanism is enhanced. The close-packed heating mechanism in this embodiment is identical with the close-packed heating mechanism in Embodiment 1-2 in other structures, and will not be detailed anymore here.

The close-packed heating mechanism in this embodiment is identical with the close-packed heating mechanism in Embodiment 1-1, and will not be detailed here.

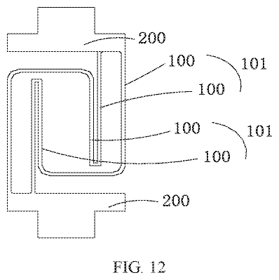

Embodiment 1-12. As shown in FIG. 12, a close-packed heating mechanism in this embodiment is improved based on Embodiment 1-1 in the following aspects: the distance between adjacent circuit groups 101 is less than 0.5 mm to form a close-packed structure, and the distance between two adjacent heating circuits 100 in the same circuit group 101 is 3 mm to form a non-close-packed structure. The close-packed heating mechanism in this embodiment is identical with the close-packed heating mechanism in Embodiment 1-1 in other structures, and will not be detailed anymore here.

On the basis of the above multiple embodiments, the linear unit may be changed into a broken line formed by linear units or a zigzag arc formed by curved units to make the heating circuit 100 more circuitous, such that the contact area between the heating circuit 100 and a heating unit is large, and the resistance of the circuitous circuit can be set to be large.

The heating mechanism provided by the invention is not only suitable for metal heating circuits with a flat cross-section, but also applicable to heating circuits printed with thick films.

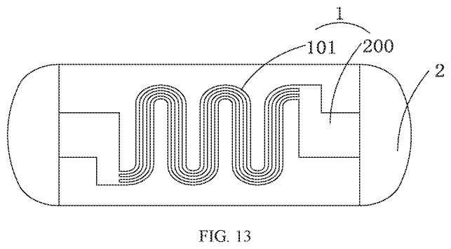

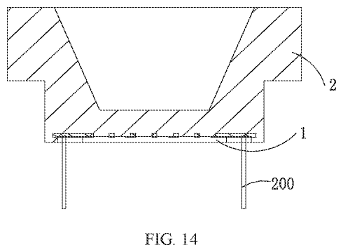

Embodiment 2: As shown in FIG. 13-FIG. 14, an atomization device comprises a liquid transfer unit 2, and the heating mechanism in Embodiment 1, wherein the heating mechanism 1 is inlaid in or attached to a surface of the liquid transfer unit. In this embodiment, the liquid transfer unit 2 is a porous ceramic unit, and the heating mechanism 1 is located at the bottom of the porous ceramic unit and is flatly attached to the bottom of the porous ceramic unit.

The porous ceramic unit is a rectangular trough structure, and the heating mechanism 1 is inlaid in the bottom of the porous ceramic unit. At least two heating circuits 100 are attached to the bottom of the porous ceramic unit.

The specific structure of the heating mechanism 1 is the same as that in Embodiment 1, and will not be detailed anymore here.

1. A close-packed heating mechanism, comprising heating circuits configured for evaporating liquid, and electrodes configured for being connected to a power supply unit, characterized in that at least two said heating circuits are disposed between two electrodes in parallel to form a circuit group, and all the heating circuits in the circuit group extend from one of the electrodes to the other of the electrodes;
wherein in an arrangement pattern formed by all the heating circuits,
a distance between adjacent heating circuits in the circuit group or a distance between at least parts of adjacent circuit groups is less than 0.5 mm to form a close-packed structure; or, a distance between at least parts of the adjacent heating circuits in the circuit group and a distance between at least parts of the adjacent circuit groups are less than 0.5 mm to form a close-packed structure; and
a distance between other parts of the adjacent heating circuits and the adjacent circuit groups is greater than the distance in the close-packed structure.

2. The close-packed heating mechanism according to claim 1, characterized in that the distance between the adjacent heating circuits in the close-packed structure is 0.01-0.5 mm.

3. The close-packed heating mechanism according to claim 1, characterized in that each of the heating circuits is a linear unit, a curved unit, or a structure formed by end-to-end connection or intersection of at least one of the linear unit or the curved unit.

4. The close-packed heating mechanism according to claim 1, characterized in that each of the heating circuits has a diameter or width, which is constant or substantially constant, or gradually increases or decreases or is regular with respect to a center of the heating mechanism.

5. The close-packed heating mechanism according to claim 1, characterized in that multiple said heating circuits are the same or substantially the same in diameter or width.

6. The close-packed heating mechanism according to claim 1, characterized in that all the heating circuits have a diameter or width, which gradually increases or decreases or is regular with respect to a center of the heating mechanism.

7. The close-packed heating mechanism according to claim 1, characterized in that in the circuit group, the distance between the adjacent heating circuits keeps constant from one end to other end, or gradually decreases from a middle to two ends of the heating circuits, or gradually increases from the middle to the two ends of the heating circuits.

8. The close-packed heating mechanism according to claim 1, characterized in that all the heating circuits are of an integrally-formed integrated structure.

9. The close-packed heating mechanism according to claim 1, characterized in that two adjacent said heating circuits are connected through reinforcing members.

10. The close-packed heating mechanism according to claim 9, characterized in that all the reinforcing members are uniformly distributed on the heating circuits; or, all the reinforcing members are arranged symmetrically with respect to a middle of the heating circuits; or, all the reinforcing members are disposed at bends or turns.

11. The close-packed heating mechanism according to claim 9, characterized in that the reinforcing members are rod-shaped, strip-shaped or plate-shaped, and are in a linear shape, a curved shape, or in a shape of the combination of at least one linear shape and/or curved shape.

12. An atomization device, comprising a liquid transfer unit, and the heating mechanism according to claim 1, characterized in that the heating mechanism is inlaid in or attached to a surface of the liquid transfer unit.

13. The atomization device according to claim 12, characterized in that the distance between the adjacent heating circuits in the close-packed structure is 0.01-0.5 mm.

14. The atomization device according to claim 12, characterized in that each of the heating circuits is a linear unit, a curved unit, or a structure formed by end-to-end connection or intersection of at least one of the linear unit or the curved unit.

15. The atomization device according to claim 12, characterized in that each of the heating circuits has a diameter or width, which is constant or substantially constant, or gradually increases or decreases or is regular with respect to a center of the heating mechanism.

16. The atomization device according to claim 12, characterized in that multiple said heating circuits are the same or substantially the same in diameter or width.

17. The atomization device according to claim 12, characterized in that in the circuit group, the distance between the adjacent heating circuits keeps constant from one end to other end, or gradually decreases from a middle to two ends of the heating circuits, or gradually increases from the middle to the two ends of the heating circuits.

18. The atomization device according to claim 12, characterized in that all the heating circuits are of an integrally-formed integrated structure.

19. The atomization device according to claim 12, characterized in that two adjacent said heating circuits are connected through reinforcing members.

20. The atomization device according to claim 19, characterized in that all the reinforcing members are uniformly distributed on the heating circuits; or, all the reinforcing members are arranged symmetrically with respect to a middle of the heating circuits; or, all the reinforcing members are disposed at bends or turns.
